(19) United States
(12) Patent Application Publication
(10) Pub. No.: US 2021/0258314 A1
(43) Pub. Date: Aug. 19, 2021

(54) METHOD AND SYSTEM FOR USER AUTHENTICATION

(71) Applicant: Kosay Mohamad Tabaja, Hawalli (KW)

(72) Inventor: Kosay Mohamad Tabaja, Hawalli (KW)

(21) Appl. No.: 16/790,777

(22) Filed: Feb. 14, 2020

(51) Int. Cl. H04L 29/06; H04L 12/24

(52) U.S. Cl. CPC H04L 63/102; H04L 63/107; H04L 41/22; H04L 63/0846; H04L 63/0838

(57) ABSTRACT

A method and a system for user login authentication are provided. The system receives an input of username from a user. The system prompts the user to select one or more types of attributes followed by an input of the one or more attributes associated with the selection. The system receives an input of password from the user. The system generates a user identity by combining the username, the selected attributes, and a system generated attribute. The system authenticates the user by comparing the generated user identity and the password with corresponding entries created and saved earlier in a user login profile.

### BACKGROUND

In general, user authentication is required to gain access to an operating system, a computer application, a website, etc. Conventional authentication typically depends on a fixed username and password combination. The password can be one-time password (OTP), or a fixed password. A common technology used for the delivery of one-time passwords is text messaging, or short messaging service (SMS). However, incorporating an one-time password solution, i.e., sending one-time password messages is very expensive especially for an enterprise environment, or intranet users. Moreover, one-time password messages are less secure, because the one-time password messages are transported on the global SS7 network which is unencrypted, unauthenticated, and has no integrity protection.

Therefore, there is long felt need for a secure and cost efficient user authentication.

### SUMMARY OF THE INVENTION

This summary is provided to introduce a selection of concepts in a simplified form that are further disclosed in the detailed description of the invention. This summary is not intended to identity key or essential inventive concepts of the claimed subject matter, nor is it intended for determining the scope of the claimed subject matter.

The method and system disclosed herein addresses the above recited need for a secure and cost efficient user authentication. The method comprises creating a user login profile and then using the created user login profile for user login authentication.

The method for creating the user login profile comprises a client application executable by at least one processor configured to manage a graphical user interface of an user device and actions associated with the creation of user login profile. To create the user login profile, the client application displays a login user interface on the user device. The login user interface comprises a plurality of fields to enter a username, one or more attributes associated with the username, and a password. The attributes comprises one or more of date, day, current hour, current minute, location, math equation, word based on date, word based on time, word plus number based on date, word plus number based on time, and any combination thereof. The client application receives an input of the username from a user. The client application prompts the user to select one or more types of the attribute followed by an input of one or more attributes associated with the selection. The client application receives an input of the password from the user. The client application generates a user identity by combining the username, the selected attributes, and a system generated attribute. The client application creates the user login profile for the user using the generated user identity and the password, and the created user login profile is saved in a database along with the system generated attribute.

The method for user login authentication comprises a client application executable by at least one processor configured to manage a graphical user interface of a user device and actions associated with the user login authentication. To perform the user login authentication, the client application displays a login user interface on the user device. The login user interface comprises multiple fields to enter a username, one or more attributes associated with the username, and a password. The client application receives an input of the username from a user. The client application prompts the user to select one or more types of the attribute followed by an input of one or more attributes associated with the selection. The client application receives an input of the password from the user. The client application generates a user identity by combining the username, the selected attributes, and the previously saved system generated attribute. The client application authenticates the user by comparing the generated user identity and the password with corresponding entries created and saved earlier in a user login profile. If the user is unable to login after a predetermined number of login attempts the client application sends a one-time password to a registered device of the user to enable the user to re-create the user login profile.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1 exemplarily illustrates a method for creating a user login profile.

FIG. 2 exemplarily illustrates a method for user login authentication

FIG. 3 exemplarily illustrates a screenshot of a login user interface for creating a user login profile and for performing user login authentication.

FIG. 4 exemplarily illustrates a system for creating a user login profile and for performing user login authentication.

### DETAILED DESCRIPTION OF THE INVENTION

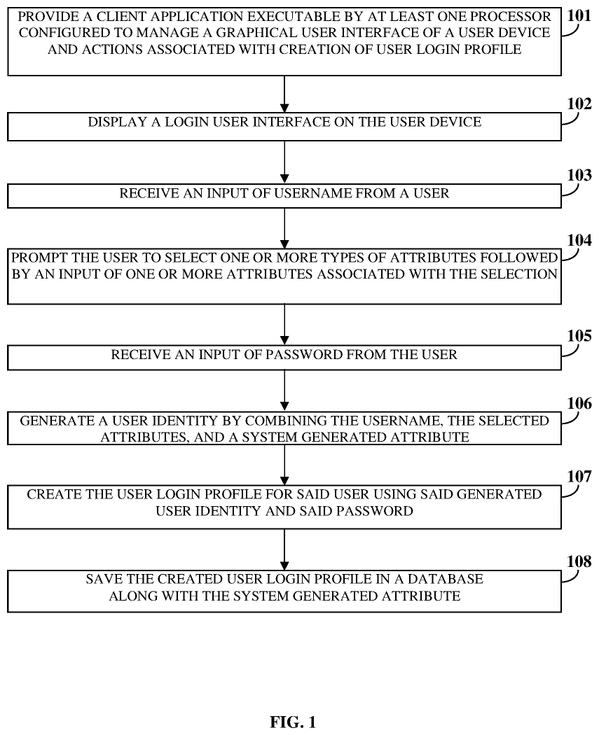

FIG. 1 exemplarily illustrates a method for creating a user login profile. The method disclosed herein provides 101 a client application executable by at least one processor configured to manage a graphical user interface of a user device 402 and actions associated with the creation of user login profile. To create the user login profile, the client application displays 102 a login user interface 300 on the user device 402. The login user interface 300 comprises multiple fields to enter a username, one or more attributes associated with the username, and a password. The client application receives 103 an input of the username from a user. The client application prompts 104 the user to select one or more types of the attribute followed by an input of one or more attributes associated with the selection. The types of attributes comprises one or more of date, day, current hour, current minute, location, math equation, word based on date, word based on time, word plus number based on date, word plus number based on time, and any combination thereof. The client application receives 105 an input of the password from the user. The client application generates 106 a user identity by combining the username, the selected attributes, and a system generated attribute. The client application creates 107 the user login profile for the user using the generated user identity and the password. The created user login profile is saved 108 in a database along with the system generated attribute.

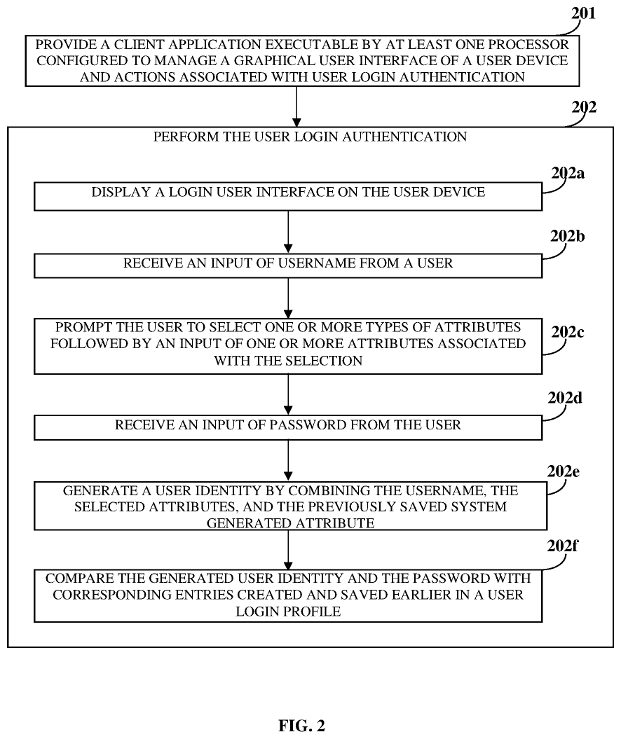

FIG. 2 exemplarily illustrates a method for user login authentication. The method disclosed herein provides 201 a client application executable by at least one processor configured to manage a graphical user interface of a user device 402 and actions associated with the user login authentication. To perform 202 the user login authentication, the client application displays 202a a login user interface 300 on the user device 402. The login user interface 300 comprises multiple fields to enter a username, one or more attributes associated with the username, and a password. The client application receives 202b an input of the username from a user. The client application prompts 202c the user to select one or more types of attributes followed by an input of one or more attributes associated with the selection. The types of the attributes comprises one or more of date, day, current hour, current minute, location, math equation, word based on date, word based on time, word plus number based on date, word plus number based on time, and any combination thereof. The client application receives 202d an input of the password from the user. The client application generates 202e a user identity by combining the username, the selected attributes, and the previously saved system generated attribute. The client application authenticates the user login by comparing 202f the generated user identity and the password with corresponding entries in a user login profile stored in a database. The client application further sends a one-time password to a registered device of the user when the user is unable to login after a predetermined number of login attempts to enable the user to re-create the user login profile.

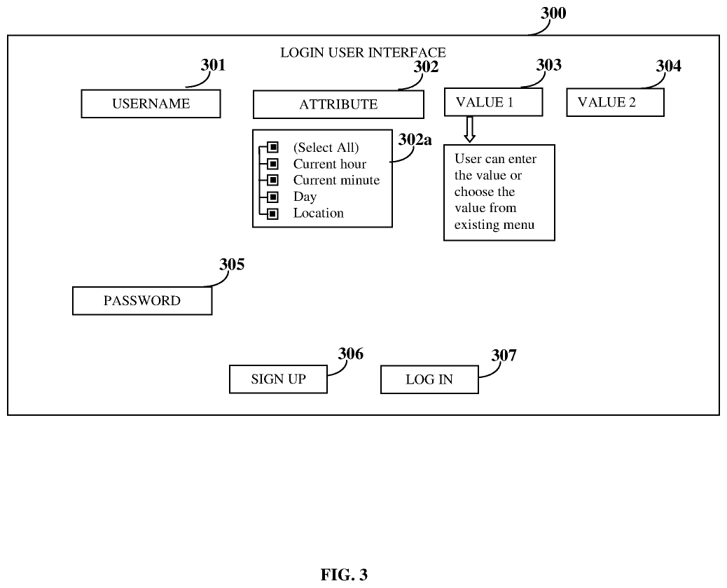

FIG. 3 exemplarily illustrates a screenshot of a login user interface 300 for creating a user login profile and for performing user login authentication. As exemplarily illustrated in FIG. 3, the login user interface 300 comprises multiple fields 301, 302, 303, 304, and 305 to enter a username, one or more attributes associated with the username, and a password. To create the user login profile the user inputs a username into the field 301. The user selects one or more types of the attribute in the field 302a, followed by an input of one or more attributes into the fields 303 and 304 associated with the selection. The user inputs a password into the field 305. Types of the attributes comprise one or more of date, day, current hour, current minute, location, math equation, word based on date, word based on time, word plus number based on date, word plus number based on time, and any combination thereof. The client application generates a user identity by combining the username, the values of the selected attributes and a system generated attribute, as exemplarily illustrated in the equation below. The user selects the field 306 to create the user login profile. The client application creates the user login profile for the user using the generated user identity and the password. The created user login profile is saved in a database along with the system generated attribute.

### Equation:

User identity=Username+Value 0+Value 1+Value X
Username=Fixed for each user
Value 0=variable value
Value 1=variable value
Value X=system attribute=date or time or any equation or algorithm

As exemplarily illustrated in FIG. 3, to login into a system, for example, an operating system, a computer application, a website, etc., the user inputs a username into the field 301. The user selects one or more types of the attribute in the field 302a, followed by an input of one or more attributes into the fields 303 and 304 associated with the selection. The user inputs a password into the field 305. Types of the attributes comprise one or more of date, day, current hour, current minute, location, math equation, word based on date, word based on time, word plus number based on date, word plus number based on time, and any combination thereof. The client application generates a user identity by combining the username, the values of the selected first attributes, and the previously saved system generated attribute, as exemplarily illustrated in the equation above. The user selects the filed 307 to login into the system. The client application performs the user login authentication by comparing the generated user identity and the password with corresponding entries created and saved earlier in the user login profile.

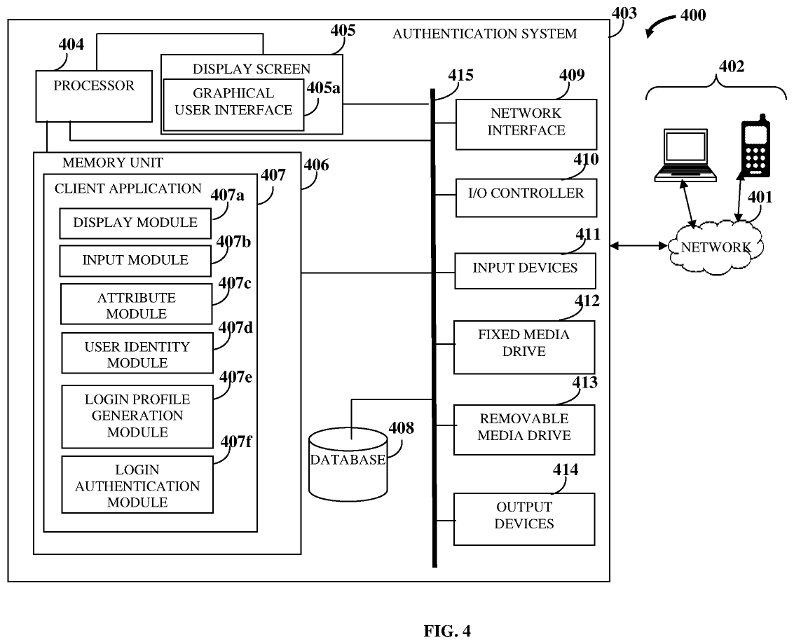

FIG. 4 exemplarily illustrates a computer implemented system 400 comprising an authentication system 403 for creating a user login profile and for performing user login authentication. The authentication system 403 is a computer system that is programmable using a high level computer programming language. In an embodiment, the authentication system 403 uses programmed and purposeful hardware. The authentication system 403 is implemented on a computing device, for example, a personal computer, a tablet computing device, a mobile computer, a portable computing device, a laptop, a touch device, a workstation, a server, portable electronic device, a network enabled computing device, an interactive network enabled communication device, any other suitable computing equipment, combinations of multiple pieces of computing equipment, etc. In an embodiment, the computing equipment is used to implement applications such as media playback applications, a web browser, an electronic mail (email) application, a calendar application, etc. In another embodiment, the computing equipment, for example, one or more servers are associated with one or more online services. In an embodiment, the authentication system 403 is configured as a web based platform, for example, a website hosted on a server or a network of servers.

The authentication system 403 communicates with user devices 402 via the network 401, for example, a short range network or a long range network. The user devices 402 comprise electronic devices, for example, personal computers, tablet computing devices, mobile computers, mobile phones, smartphones, portable computing devices, personal digital assistants, laptops, wearable computing devices such as the Google Glass® of Google Inc., the Apple Watch® of Apple Inc., etc., touch centric devices, client devices, portable electronic devices, network enabled computing devices, interactive network enabled communication devices, any other suitable computing equipment, combinations of multiple pieces of computing equipment, etc. In an embodiment, the user devices 402 are hybrid computing devices that combine the functionality of multiple devices. Examples of a hybrid computing device comprise a cellular telephone that includes a media player functionality, a gaming device that includes a wireless communications capability, a cellular telephone that includes a document reader and multimedia functions, and a portable device that has network browsing, document rendering, and network communication capabilities.

The network 401 is, for example, the internet, an intranet, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks. In an embodiment, the authentication system 403 is accessible to a satellite internet of users, for example, through a broad spectrum of technologies and devices such as cellular phones, tablet computing devices, etc., with access to the internet.

As exemplarily illustrated in FIG. 4, authentication system 403 comprises a non-transitory computer readable storage medium, for example, a memory unit 406 for storing programs and data, and at least one processor 404 communicatively coupled to the non-transitory computer readable storage medium. As used herein, “non-transitory computer readable storage medium” refers to all computer readable media, for example, non-volatile media, volatile media, and transmission media, except for a transitory, propagating signal. Non-volatile media comprise, for example, solid state drives, optical discs or magnetic disks, and other persistent memory volatile media including a dynamic random access memory (DRAM), which typically constitute a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to the processor 404. The non-transitory computer readable storage medium is configured to store computer program instructions defined by modules, for example, 407a-407f etc., of the authentication system 403. The modules 407a-407f are installed and stored in the memory unit 406 of the authentication system 403. The memory unit 406 is used for storing program instructions, applications, and data. The memory unit 406 is, for example, a random access memory (RAM) or another type of dynamic storage device that stores information and instructions for execution by the processor 404. The memory unit 406 also stores temporary variables and other intermediate information used during execution of the instructions by the processor 404. The authentication system 403 further comprises a read only memory (ROM) or another type of static storage device that stores static information and instructions for the processor 404.

The processor 404 is configured to execute the computer program instructions defined by the modules, for example, 407a-407f, etc., of the authentication system 403. The processor 404 refers to any of one or more microprocessors, central processing unit (CPU) devices, finite state machines, computers, microcontrollers, digital signal processors, logic, a logic device, a user circuit, an application specific integrated circuit (ASIC), a field-programmable gate array (FPGA), a chip, etc., or any combination thereof, capable of executing computer programs or a series of commands, instructions, or state transitions. In an embodiment, the processor 404 is implemented as a processor set comprising, for example, a programmed microprocessor and a math or graphics co-processor. The processor 404 is selected, for example, from the Intel® processors such as the Itanium® microprocessor or the Pentium® processors, Advanced Micro Devices (AMD®) processors such as the Athlon® processor, UltraSPARC® processors, microSPARC® processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The authentication system 403 disclosed herein is not limited to employing a processor 404. In an embodiment, the authentication system 403 employs a controller or a microcontroller.

As exemplarily illustrated in FIG. 4, the authentication system 403 further comprises a data bus 415, a network interface 409, an input/output (I/O) controller 410, input devices 411, a fixed media drive 412 such as a hard drive, a removable media drive 413 for receiving removable media, output devices 414, etc. The data bus 415 permits communications between the modules, for example, 407a-407f etc., of the authentication system 403. The network interface 409 enables connection of authentication system 403 to the network 401. In an embodiment, the network interface 409 is provided as an interface card also referred to as a line card. The network interface 409 comprises, for example, one or more of an infrared (IR) interface, an interface implementing Wi-Fi® of Wi-Fi Alliance Corporation, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, Ethernet communication interfaces, asynchronous transfer mode (ATM) interfaces, a high speed serial interface (HSSI), a fiber distributed data interface (FDDI), interfaces based on a transmission control protocol (TCP)/internet protocol (IP), interfaces based on wireless communications technology such as satellite technology, radio frequency (RF) technology, near field communication, etc. The I/O controller 410 controls input actions and output actions performed by the authentication system 403.

The display screen 405, via the graphical user interface (GUI) 405a, displays multiple fields to enter a username, one or more first attributes associated with the username, a password, and one or more second attributes associated with the password. The display screen 405 is, for example, a video display, a liquid crystal display, a plasma display, an organic light emitting diode (OLED) based display, etc. The authentication system 403 provides the GUI 405a on the display screen 405. The GUI 405a is, for example, an online web interface, a web based downloadable application interface, a mobile based downloadable application interface, etc. The display screen 405 displays the GUI 405a. The input devices 411 are used for inputting data into the authentication system 403. The input devices 411 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc. The output devices 414 output the results of operations performed by the authentication system 403.

The authentication system 403 comprises a client application 407. The modules of the client application 407 comprise a display module 407a, an input module 407b, an attribute module 407c, a user identity module 407d, a login profile generation module 407e and a login authentication module 407f stored in the memory unit 406 of the authentication system 403. The display module 407a displays a login user interface 300 on the user device 402. The login user interface 300 comprises multiple fields to enter a username, one or more attributes associated with the username, and a password. The input module 407b receives an input of the username from a user. The attribute module 407c prompts the user to select one or more types of the attribute followed by an input of one or more attributes associated with the selection. The input module 407b receives an input of the password from the user. The user identity module 407d generates a user identity by combining the username, the selected attributes, and a system generated attribute. The login profile generation module 407e creates the user login profile for the user using the generated user identity and the password. The client application 407 saves the created user login profile in the database 408 along with the system generated attribute. The login authentication module 407f authenticates the user by comparing the generated user identity and the password with corresponding entries created and saved earlier in the user login profile. The authentication system 403 further comprises a short message service module to send a one-time password to a registered device of the user when the user is unable to login after a predetermined number of login attempts to enable the user to re-create the user login profile.

The non-transitory computer readable storage medium disclosed herein stores computer program codes that comprise instructions executable by at least one processor for creating a user login profile and for performing user login authentication. The computer program codes comprise codes for creating a user login profile and codes for performing user login authentication. The codes for creating the user login profile comprises a first computer program code for displaying a login user interface on the user device, wherein the login user interface comprises a plurality of fields to enter a username, one or more attributes associated with the username, and a password; a second computer program code for receiving an input of the username from a user; a third computer program code for prompting the user to select one or more types of the attribute followed by an input of one or more the attributes associated with the selection; a fourth computer program code for receiving an input of the password from the user; a fifth computer program code for generating a user identity by combining the username, the selected attributes, and a system generated attribute; a sixth computer program code for creating the user login profile for the user using the generated user identity and the password; and a seventh computer program code for saving the created user login profile in a database along with the system generated attribute.

The codes for performing user login authentication comprise an eighth computer program code for displaying a login user interface on the user device, wherein the login user interface comprises a plurality of fields to enter a username, one or more attributes associated with the username, and a password; a ninth computer program code for receiving an input of the username from a user; a tenth computer program code for prompting the user to select one or more types of the attribute followed by an input of one or more attributes associated with the selection; an eleventh computer program code for receiving an input of the password from the user; a twelfth computer program code for generating a user identity by combining the username, the selected attributes, and the previously saved system generated attribute; and a thirteenth computer program code for authenticating the user by comparing the generated user identity and the password with corresponding entries created and saved earlier in a user login profile. The computer program codes further comprise a fourteenth computer program code for sending an one-time password to a registered device of the user when the user is unable to login after a predetermined number of login attempts to enable the user to re-create the user login profile.

It will be readily apparent in different embodiments that the various methods, algorithms, and computer programs disclosed herein are implemented on non-transitory computer readable storage media appropriately programmed for computing devices. The non-transitory computer readable storage media participates in providing data, for example, instructions that are read by a computer, a processor or a similar device. In different embodiments, the “non-transitory computer readable storage media” further refers to a single medium or multiple media, for example, a centralized database, a distributed database, and/or associated caches and servers that store one or more sets of instructions that are read by a computer, a processor or a similar device. The “non-transitory computer readable storage media” further refers to any medium capable of storing or encoding a set of instructions for execution by a computer, a processor or a similar device and that causes a computer, a processor or a similar device to perform any one or more of the methods disclosed herein. Common forms of non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in a number of manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C#, Java®, JavaScript®, Fortran, Ruby, Peri®, Python®, Visual Basic®, hypertext preprocessor (PHP), Microsoft® .NET, Objective-C®, etc. Other object-oriented, functional, scripting, and/or logical programming languages can also be used. In an embodiment, the computer program codes or software programs are stored on or in one or more mediums as object code. In another embodiment, various aspects of the method and the authentication system 403 disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. In another embodiment, various aspects of the method and the authentication system 403 disclosed herein are implemented as programmed elements, or non-programmed elements, or any suitable combination thereof.

Where databases 408 are described, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere Similarly, any illustrated entries of the databases represent exemplary information only; one of ordinary skill in the art will understand that the number and content of the entries can be different from those disclosed herein. In another embodiment, despite any depiction of the databases as tables, other formats including relational databases, object-based models, and/or distributed databases are used to store and manipulate the data types disclosed herein. Object methods or behaviors of a database can be used to implement various processes such as those disclosed herein. In another embodiment, the databases are, in a known manner, stored locally or remotely from a device that accesses data in such a database. In embodiments where there are multiple databases in the authentication system 403, the databases are integrated to communicate with each other for enabling simultaneous updates of data linked across the databases, when there are any updates to the data in one of the databases.

The method and the authentication system 403 disclosed herein can be configured to work in a network environment comprising one or more computers that are in communication with one or more devices via a network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on the type of computer, the operating system provides the appropriate communications protocols to establish communication links with the network. Any number and type of machines may be in communication with the computers.

The computer implemented method and the authentication system 403 disclosed herein are not limited to a particular computer system platform, processor, operating system, or network. In an embodiment, one or more aspects of the computer implemented method and the authentication system 403 disclosed herein are distributed among one or more computer systems, for example, servers configured to provide one or more services to one or more client computers, or to perform a complete task in a distributed system. For example, one or more aspects of the computer implemented method and the authentication system 403 disclosed herein are performed on a client-server system that comprises components distributed among one or more server systems that perform multiple functions according to various embodiments. These components comprise, for example, executable, intermediate, or interpreted code, which communicate over a network using a communication protocol. The computer implemented method and the authentication system 403 disclosed herein are not limited to be executable on any particular system or group of systems, and are not limited to any particular distributed architecture, network, or communication protocol.

The foregoing examples have been provided merely for explanation and are in no way to be construed as limiting of the method and the authentication system 403 disclosed herein. While the method and the authentication system 403 have been described with reference to various embodiments, it is understood that the words, which have been used herein, are words of description and illustration, rather than words of limitation. Furthermore, although the method and the authentication system 403 have been described herein with reference to particular means, materials, and embodiments, the method and the authentication system 403 are not intended to be limited to the particulars disclosed herein; rather, the method and the authentication system 403 extend to all functionally equivalent structures, methods and uses, such as are within the scope of the appended claims. While multiple embodiments are disclosed, it will be understood by those skilled in the art, having the benefit of the teachings of this specification, that the method and authentication system 403 disclosed herein are capable of modifications and other embodiments may be effected and changes may be made thereto, without departing from the scope and spirit of the method and the authentication system 403 disclosed herein.

I claim:

1. A method for creating a user login profile, comprising:
providing a client application executable by at least one processor configured to manage a graphical user interface of a user device and actions associated with said creation of user login profile;
displaying a login user interface on said user device by said client application, wherein said login user interface comprises a plurality of fields to enter a username, one or more attributes associated with said username, and a password;
receiving an input of said username from a user by said client application;
prompting said user to select one or more types of said attribute followed by an input of said one or more said attributes associated with said selection by said client application;
receiving an input of said password from said user by said client application;
generating a user identity by combining said username, said selected attributes, and a system generated attribute by said client application;
creating said user login profile for said user, by said client application, using said generated user identity and said password; and
saving said user login profile in a database along with the system generated attribute, by said client application.

2. The method of claim 1, wherein said types of said attributes comprises one or more of date, day, current hour, current minute, location, math equation, word based on date, word based on time, word plus number based on date, word plus number based on time, and any combination thereof.

3. A method for user login authentication, comprising:
providing a client application executable by at least one processor configured to manage a graphical user interface of a user device and actions associated with said user login authentication;
performing said user login authentication, comprising:
displaying a login user interface on said user device by said client application, wherein said login user interface comprises a plurality of fields to enter a username, one or more attributes associated with said username, and a password;
receiving an input of said username from a user by said client application;
prompting said user to select one or more types of said attribute followed by an input of said one or more attributes associated with said selection by said client application;
receiving an input of said password from said user by said client application;
generating a user identity by combining said username, said selected attributes, and the previously saved system generated attribute, by said client application;
comparing said generated user identity and said password with corresponding entries created and saved earlier in a user login profile stored by said client application.

4. The method of claim 3, wherein said types of said attributes comprises one or more of date, day, current hour, current minute, location, math equation, word based on date, word based on time, word plus number based on date, word plus number based on time, and any combination thereof.

5. The method of claim 3, further comprising sending, by said client application, an one-time password to a registered device of said user when said user is unable to login after a predetermined number of login attempts to enable said user to re-create said user login profile.

6. A system for creating a user login profile, comprising:
at least one processor configured to execute a client application to manage a graphical user interface of an user device and actions associated with said creation of user login profile;
a non-transitory computer readable storage medium communicatively coupled to said at least one processor, said non-transitory computer readable storage medium configured to store said client application;
said client application, comprising:
a display module to display a login user interface on said user device, wherein said login user interface comprises a plurality of fields to enter a username, one or more attributes associated with said username, and a password;
an input module to receive an input of said username from a user;
an attribute module to prompt said user to select one or more types of said attributes followed by an input of said one or more attributes associated with said selection;
said input module to receive an input of said password from said user;
a user identity module to generate a user identity by combining said username, said selected attributes, and a system generated attribute;
a login profile generation module to create said user login profile for said user using said generated user identity and said password; and
a database for saving said created user login profile along with the system generated attribute.

7. The system of claim 6, wherein said types of said attributes comprises one or more of date, day, current hour, current minute, location, math equation, word based on date, word based on time, word plus number based on date, word plus number based on time, and any combination thereof.

8. A system for user login authentication, comprising:
at least one processor configured to execute a client application to manage a graphical user interface of an user device and actions associated with said user login authentication;
a non-transitory computer readable storage medium communicatively coupled to said at least one processor, said non-transitory computer readable storage medium configured to store said client application;
said client application, comprising:
a display module to display displaying a login user interface on said user device, wherein said login user interface comprises a plurality of fields to enter a username, one or more attributes associated with said username, and a password;
an input module to receive an input of said username from a user;
an attribute module to prompt said user to select one or more types of said attributes followed by an input of said one or more attributes associated with said selection;
said input module to receive an input of said password from said user;
a user identity module to generate a user identity by combining said username, said selected attributes, and the previously saved system generated attribute;
a login authentication module to authenticate said user by comparing said generated user identity and said password with corresponding entries created and saved earlier in a user login profile.

9. The system of claim 8, wherein said types of said attributes comprises one or more of date, day, current hour, current minute, location, math equation, word based on date, word based on time, word plus number based on date, word plus number based on time, and any combination thereof.

10. The system of claim 8, further comprising a short message service module to send a one-time password to a registered device of said user when said user is unable to login after a predetermined number of login attempts to enable said user to re-create said user login profile.

11. A computer program product comprising a non-transitory computer readable storage medium, said non-transitory computer readable storage medium storing computer program codes that comprise instructions executable by at least one processor for creating a user login profile and for performing user login authentication, said computer program codes comprising:
creating a user login profile comprising:
a first computer program code for displaying a login user interface on said user device, wherein said login user interface comprises a plurality of fields to enter a username, one or more attributes associated with said username, and a password;
a second computer program code for receiving an input of said username from a user;
a third computer program code for prompting said user to select one or more types of said attributes followed by an input of said one or more attributes associated with said selection;
a fourth computer program code for receiving an input of said password from said user;
a fifth computer program code for generating a user identity by combining said username, said selected attributes, and a system generated attribute;
a sixth computer program code for creating said user login profile for said user using said generated user identity and said password;
a seventh computer program code for saving said created user login profile in a database along with the system generated attribute; and
performing user login authentication comprising:
an eighth computer program code for displaying a login user interface on said user device, wherein said login user interface comprises a plurality of fields to enter a username, one or more attributes associated with said username, and a password;
a ninth computer program code for receiving an input of said username from a user;
a tenth computer program code for prompting said user to select one or more types of said attributes followed by an input of said one or more attributes associated with said selection;
an eleventh computer program code for receiving an input of said password from said user;
a twelfth computer program code for generating a user identity by combining said username, said selected attributes, and the previously saved system generated attribute; and
a thirteenth computer program code for authenticating said user by comparing said generated user identity and said password with corresponding entries created and saved earlier in a user login profile.

12. The computer program product of claim 11, wherein said types of said attributes comprises one or more of date, day, current hour, current minute, location, math equation, word based on date, word based on time, word plus number based on date, word plus number based on time, and any combination thereof.

13. The computer program product of claim 11, further comprising a fourteenth computer program code for sending an one-time password to a registered device of said user when said user is unable to login after a predetermined number of login attempts to enable said user to re-create said user login profile.
